(19) United States
(12) Patent Application Publication
(10) Pub. No.: US 2017/0371627 A1
(43) Pub. Date: Dec. 28, 2017

(54) OBJECT-ORIENTED CONTAINER CLASS CALLBACKS

(71) Applicant: International Business Machines Corporation, Armonk, NY (US)

(72) Inventor: Geoffrey D. Alexander, Banner Elk, NC (US)

(21) Appl. No.: 15/195,120

(22) Filed: Jun. 28, 2016

(51) Int. Cl. G06F 9/44

(52) U.S. Cl. CPC G06F 8/315

(57) ABSTRACT

A computer-implemented method includes associating callback code with an instance of a container class. The callback code includes a callback operation to be performed automatically responsive to a container action. Initiation of the container action in the instance of the container class is detected. The callback code is automatically executed, by a computer processor, responsive to the initiation of the container action.

### BACKGROUND

Embodiments of the present invention relate to callbacks and, more specifically, to object-oriented container class callbacks.

Most modern object-oriented computer programming languages offer a wide variety of container, or collection, classes. For example, C++ offers a number of sequence, associative, and unordered associative container classes. Similarly, Java offers a wide range of container classes via the java.util.Collection interface. Generally, a container may be used to collect a group of items having a similar type. For example, containers can include lists, sets, maps, and queues.

Often, a user will want to perform a task when a container is modified, such as when an item is added to or removed from a container. For example, if a container is a set of coordinate pairs being used as a map, then upon adding a coordinate pair, the user may want to calculate distances to nearby coordinate pairs in the set. A user may wish to perform this task upon each addition of a new coordinate pair to the set. Conventionally, when a programmer wishes to perform certain code responsive each modification of a container, the programmer includes that code at every point at which the container could be modified.

### SUMMARY

According to an embodiment of this disclosure, a computer-implemented method includes associating callback code with an instance of a container class. The callback code includes a callback operation to be performed automatically responsive to a container action. Initiation of the container action in the instance of the container class is detected. The callback code is automatically executed, by a computer processor, responsive to the initiation of the container action.

In another embodiment, a system includes a memory having computer readable instructions and one or more processors for executing the computer readable instructions. The computer readable instructions include associating callback code with an instance of a container class. The callback code includes a callback operation to be performed automatically responsive to a container action. Further according to the computer readable instructions, initiation of the container action in the instance of the container class is detected. The callback code is automatically executed, responsive to the initiation of the container action.

In yet another embodiment, a computer program product for container class callback includes a computer readable storage medium having program instructions embodied therewith. The program instructions are executable by a processor to cause the processor to perform a method. The method includes associating callback code with an instance of a container class. The callback code includes a callback operation to be performed automatically responsive to a container action. Further according to the method, initiation of the container action in the instance of the container class is detected. The callback code is automatically executed, responsive to the initiation of the container action.

Additional features and advantages are realized through the techniques of the present invention. Other embodiments and aspects of the invention are described in detail herein and are considered a part of the claimed invention. For a better understanding of the invention with the advantages and the features, refer to the description and to the drawings.

### BRIEF DESCRIPTION OF THE DRAWINGS

The subject matter regarded as the invention is particularly pointed out and distinctly claimed in the claims at the conclusion of the specification. The foregoing and other features and advantages of the invention are apparent from the following detailed description taken in conjunction with the accompanying drawings in which:

FIG. 1 is a diagram of a callback system, according to some embodiments of this disclosure;

FIG. 2 is another diagram of the callback system, according to some embodiments of this disclosure;

FIG. 3 is a flow diagram of a method for callbacks in a container class instance, according to some embodiments of this disclosure; and

FIG. 4 is a block diagram of a computer system for implementing some or all aspects of the callback system, according to some embodiments of this disclosure.

### DETAILED DESCRIPTION

According to some embodiments, callback systems, methods, and computer program products automatically invoke established callback code upon modifications to containers, also referred to as collections. Specifically, the callback system may extend the functionality of container classes to establish callback code that is executed when actions are performed on a container class instance. Through execution of the callback code, a callback operation desired by a user may be automatically performed.

In some embodiments, callback code may be associated with a container class, such as a list, set, map, or queue. This callback code may be automatically executed whenever a container action is performed. For example, and not by way of limitation, container actions initiating the callback code may include one or more of the following: creating a new container, inserting an element into a container, removing an element from a container, removing all elements from a container, finding an element in the container, and destroying a container. In some embodiments, the callback code may be performed only when specific container actions are performed, such that the callback code is not executed when other container actions are performed.

In some embodiments, the callback code may be associated with a container class instance via an implementation based on the object-oriented Observer design pattern, container class methods or functions, global methods or functions, or other known mechanisms of associating user code with object-oriented class instances.

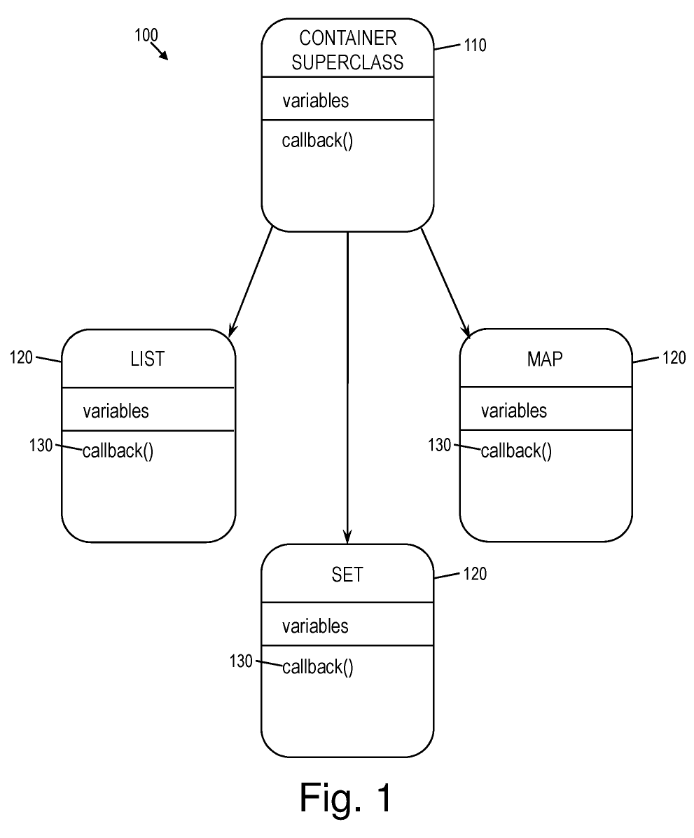

For example, in some embodiments, the callback code may be encapsulated as a method included in a container class. FIG. 1 is a block diagram of a callback system 100, according to some embodiments of this disclosure. As shown, the callback system 100 may provide a container superclass 110, to which classes 120 such as list, set, map, or others may belong. The container superclass 110 may include one or more methods, along with one or more variables in some embodiments. Among the one or more methods may be a callback method, referred to as callback( ) in FIG. 1, in which the callback code 130 discussed above may reside. This callback method may automatically execute upon the performance of an action on a container class instance.

By virtue of belonging to the superclass 110, the various classes 120 may inherit the callback method and, in some embodiments, may define that method to include operations a user wishes to be performed during a callback. In some embodiments, the callback method may be an abstract method, having no definition within the superclass 110, but enabling the classes 120 inheriting to define the method. However, this need not be the case. Rather, some embodiments may define the callback method in the superclass 110, and this definition may be overridden by the classes 120. Further, when an instance of a container class 120 is created, a user creating that instance may define the callback method upon the instantiation, and thus the callback method may be customizable by the user.

In some embodiments according to the example of FIG. 1, the callback code 130 is associated with the container class 120 at compile time. However, this need not be the case. Rather, one or more callback codes 130 may be external to a container class 120, such as by being a method in another class or a global function. In that case, an instance of the container class 120 may maintain a reference to the callback method that includes the callback code 130. For example, and not by way of limitation, the container class 120 may include a method for associating or disassociating a callback method with the instance at runtime.

In some embodiments, the callback code 130 may be defined to execute only when one of a specified set of container actions is performed, rather than upon performance of any container action. The specified set may include one or multiple types of container actions. In this case, the callback code 130 may determine the type of container action being performed by way of a parameter passed to the callback code 130 via user code, or by other known mechanisms for specifying execution time information. For example, and not by way of limitation, the callback code 130 may take a type parameter. The type parameter may indicate the specific type of container action (e.g., removing an element, adding an element) being performed. The callback code 130 may determine whether the type parameter refers to a type of container action in the specified set. If so, then the callback code 130 may proceed, including performance of a callback operation within the callback code 130. However, if the type parameter indicates a type of container action not in the specified set, then the callback code 130 may return without performing the callback operation, thus effectively skipping the callback operation.

When a container action is initiated by user code, the callback code 130 may be executed automatically before or after the container action is taken, respectively referred to as pre-operation callback code and post-operation callback code. Specifically, the callback code 130 may be performed only before the container action, only after the container action, or both before and after the container action is performed.

If the callback code 130 is executed both before and after, then when a container action is initiated by the user code, the callback code 130 may be performed, followed by the container action, followed again by the callback code 130. In such cases, a timing parameter may be passed to the callback code 130 to indicate whether the present call to the callback code 130 is occurring before or after the container action. If a user wishes a callback operation coded into the callback code 130 to be performed only before or only after the container action in such embodiments, the callback code 130 may be defined to check the timing parameter to determine whether to perform the callback operation. For instance, if the user wants the callback operation to be performed only after the container action, the callback code 130 may return without performing the callback operation if the timing parameter indicates that the container action has not yet been performed. Analogously, if the user wants the callback operation to be performed only before the container action, the callback code 130 may return without performing the callback operation if the timing parameter indicates that the container action has already been performed. Further, if the user wishes for a first callback operation to be performed before the container action, and a second callback operation to be performed after the container action, the callback code 130 may be defined to perform the first callback operation when the timing parameter indicates that the container action has not yet been performed and to perform the second callback operation when the container action has already been performed.

It will be understood that the callback code 130 may take more than a single parameter. Thus, in some embodiments, a type parameter may be used to indicate the specific container action being performed, and a timing parameter may be used to indicate whether the call to the callback code 130 is being performed before or after the container action. It will be further understood that other parameters may be used instead of or in addition to these, in various combinations. In general, the callback code 130 may perform the callback operation when predetermined performance criteria are met by the one or more parameters, and may skip the callback operation by returning without performing it when the predetermined performance criteria are not met.

In some embodiments, when a callback code 130 is associated with the instance, that callback code 130 may also be associated with one or more types of container actions. In this case, the callback code 130 may be passed the type parameter when a container action is initiated. The callback code 130 may perform its associated container operation if the type parameter matches a type associated with the callback code 130. Otherwise, the callback code 130 may return without performing the container operation. Analogously, when the callback code 130 is associated with the instance, a timing indication (i.e., pre-operation or post-operation) may also be associated with the callback code 130. When executed, the callback code 130 may compare the timing indication with the timing parameter received to determine whether to execute the callback operation.

In some embodiments, the parameters passed to the callback code 130 may include one or more parameters being passed to the container action. For example, if the container action is adding an element to a container class instance, parameters passed to the callback code 130 may include a reference to the element being added. As a result, the callback code 130 may read or write, or both, these container action parameters.

In some embodiments, the callback system 100 may provide one or more segments of callback code 130 (i.e., one or more callback codes 130), each being specifically designated to be executed automatically before a container action or specifically designated to be executed after the container action. In other words, in such embodiments, a single segment of callback code 130 need not execute both before and after the container action. Rather, pre-operation callback code may be executed before the container action, while distinct post-operation callback code may be executed after the container action.

When one or more container action parameters are passed to pre-operation callback code, the pre-operation callback code may modify the container action parameters. When multiple pre-operation callback codes are used, as will be discussed below, each such pre-operation callback code may modify the container action parameters, such that each subsequent pre-operation callback code received a version of the container action parameters as modified by the prior pre-operation callback codes, where applicable. When the pre-operation callback codes are completed, the container action may use the modified container action parameters. Further, the post-operation callback code may also use these modified container action parameters, as modified by the pre-operation callback code and the container action itself.

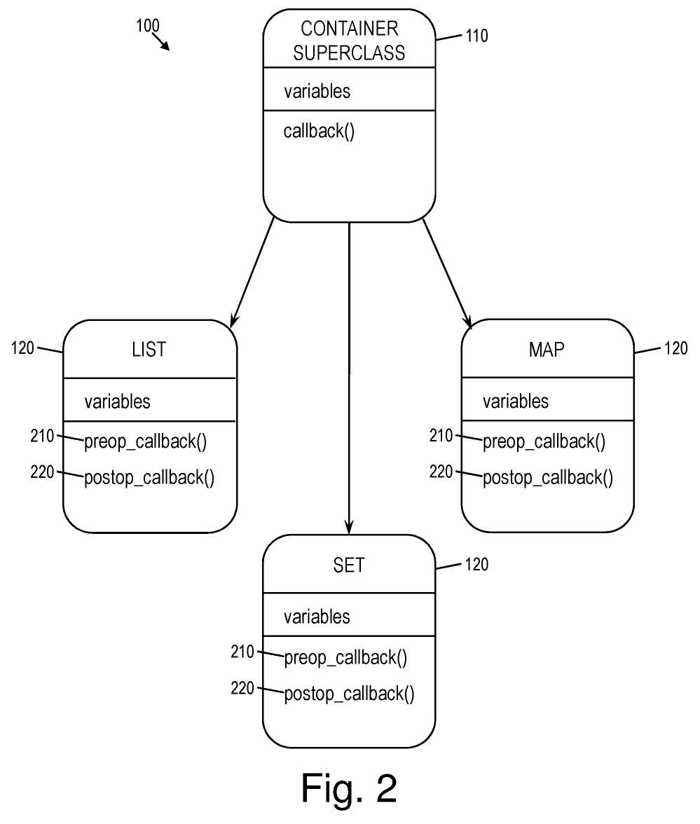

Illustrating an example of multiple callback codes 130, FIG. 2 is another block diagram of the callback system 100, according to some embodiments of this disclosure. As shown, the container superclass 110 discussed above may include a pre-operation callback method including pre-operation callback code 210, a post-operation callback method including post-operation callback code 220, or both. In FIG. 2, the pre-operation callback method appears as preop_callback( ), and the post-operation callback method appears as postop_callback( ). Upon initiation of a container action, the pre-operation callback method, if included, may be executed automatically prior to performance of the container action. Also upon initiation of a container action, the post-operation callback method, if included, may be executed automatically after performance of the container action.

In some cases, the pre-operation callback code 210 may fail in performing the callback operation it implements prior to performance of the container action. In this case, the failure may be returned by the pre-operation callback code 210. For example, and not by way of limitation, the failure may be indicated to the user code that initiated the container action, and the indication may occur by way of a legacy return code mechanism, an object-oriented exception, or other known mechanism for reporting failure. If the pre-callback operation code 210 fails, in some embodiments, the container action may be aborted or skipped.

According to some embodiments, two or more segments of callback code 130 may be automatically called responsive to initiation of a container action, and each callback code 130 may act as pre-operation callback code 210, post-operation callback code 220, or both. The user may specify an order in which the segments of callback code 130 are to be performed, as well as which are to be performed before and which are to be performed after the container action. Various approaches may be used to determine the order in which the callback codes 130 are executed.

For example, the callback codes 130 may be executed in the order in which they were associated with the container class instance. In other words, a first callback code 130 associated with the instance before a second callback code 130 was associated may be ordered before the second callback code 130 during execution. For another example, a priority may be associated to each callback code 130 when associated with the instance. The callback codes 130 may then be executed in priority order. Further, callback codes 130 having priorities exceeding an established priority threshold may be executed before the container action, while the remaining callback codes 130 may be executed after the container action. The assignment of priorities may be based on design preferences or, in some embodiments, based on the chronological order in which the callback codes 130 were associated with the instance. For yet another example, multiple callback codes 130 may be executed simultaneously as distinct operating system threads.

In some embodiments, the ordering of the callback codes 130 may be determined by defining the pre-operation callback code 210 to call one or more segments of other pre-operation code to be performed before the container action, in a desired order, or by defining the post-operation callback code 220 to call segments of other post-operation code to be performed after the container action, in a desired order, or by defining both the pre-operation callback code 210 and the post-operation callback code 220 in this manner.

In some embodiment, the execution order of multiple segments of callback code 130 already associated with a container class instance may be changed. Further, in some embodiments, callback code 130 that is currently associated with a container class instance may be disassociated from the container class instance, such that the callback code 130 is no longer called automatically responsive to a container action. This reordering or disassociating may be achieved, for example, by way of one or more container class methods or functions, global methods or functions, or other known mechanisms for reordering or disassociating user code from an object-oriented class instance.

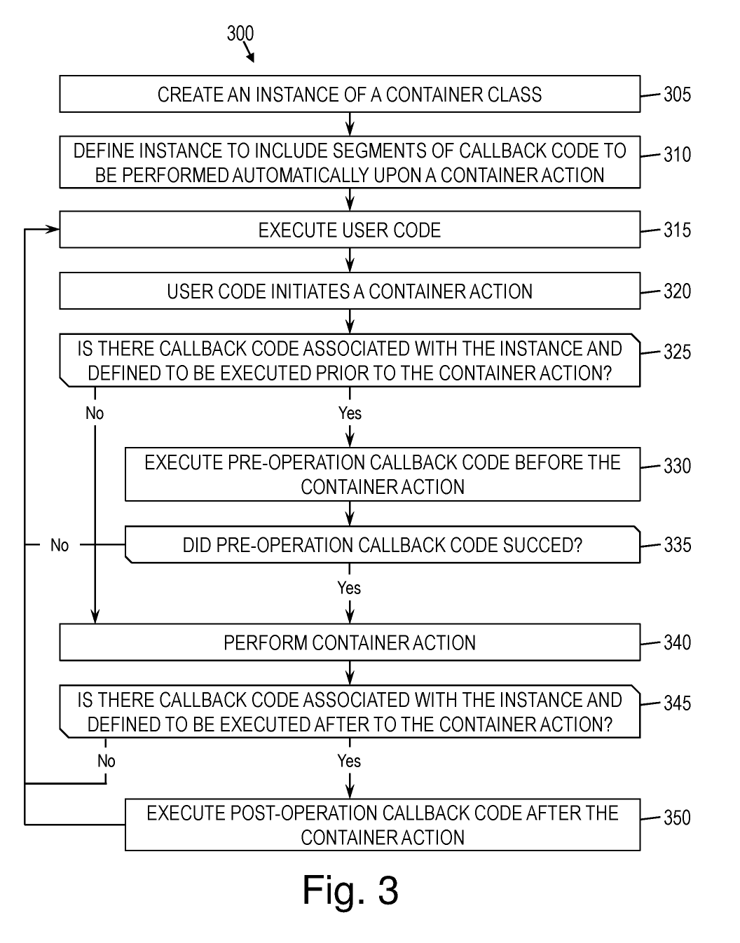

FIG. 3 is a flow diagram of a method 300 for performing a container class callback, according to some embodiments of this disclosure. As shown, at block 305, a container class instance may be created, where the container class 120 implements the callback system 100 described above. At block 310, the instance may be defined to include one or more segments of callback code 130 to be performed automatically upon initiation of a container action. In some embodiments, each segment of callback code 130 may take one or more parameters, or no parameters. Further, in some embodiments, the one or more segments of callback code 130 may include pre-operation callback code 210, post-operation callback code 220, or both. At block 315, user code may be executed. At block 320, the user code may initiate a container action on the instance created at block 310.

Responsive to initiation of the container action, at decision block 325, it may be determined whether callback code 130 associated with the instance is defined to be executed prior to the container action. This may include, for example, callback code 130 that is executed both before and after each container action or callback code 130 that is specifically designated to be executed before each container action. If such callback code 130 is identified, then at block 330, the applicable callback code 130 may be executed as pre-operation callback code 210. Additionally, in some embodiments, the callback code 130 may be passed one or more parameters to be used during execution.

At decision block 335, it may be determined whether the pre-operation callback code 210 was successful in its execution. If the pre-operation callback code 210 failed, then the method 300 may return to block 315, without executing the container action. If the pre-operation callback code 210 executed successfully, or if there was no pre-operation callback code 210, then at block 340, the initiated container action may be performed.

At decision block 345, it may be determined whether callback code 130 associated with the instance is defined to be executed after the container action. This may include, for example, callback code 130 that is executed both before and after each container action or callback code 130 that is specifically designated to be executed after each container action. If such callback code 130 is identified, then at block 350, the applicable callback code 130 may be executed as post-operation callback code 220. Additionally, in some embodiments, the callback code 130 may be passed one or more parameters to be used during execution.

Regardless of whether post-operation callback code 220 is performed, the method 300 may then return to block 315, where the user code continues to execute until another container action is performed.

It will be understood that embodiments of the callback system 100 may be used for various purposes in which a container might be useful. For example, and not by way of limitation, the callback system 100 may be used for automated theorem proving. One approach for automated theorem proving is to take a set of axioms along with the negation of a theorem to be proved, and to convert them to conjunctive normal form, also known as clause normal form. This conversion results in a conjunction of clauses, in which each clause is a disjunction of literals. Generally, the conjunction of clauses is represented as a set of clauses, and a clause is represented as a set of literals.

To prove the theorem, the theorem prover may use specific inference rules to generate new clauses, which may be added to a clause set. This may be repeated until the theorem prover can show that the clause set is unsatisfiable, at which point the theorem may be deemed proved. The determination that the clause set is unsatisfiable may be made, for example, by checking that the clause set contains the empty clause, or by testing whether the clause set is ground unsatisfiable. Thus, as new clauses are added to the clause set, the theorem prover may be required to perform its test of whether the clause set is unsatisfiable. Also in order to reduce the size of the clause set, the theorem prover may perform transformations on each new clause, such as, but not limited to, term rewriting and unit propagation, before adding the new clause to the clause set.

According to some embodiments, an appropriate transformation may be established as pre-operation callback code 210. Each time the theorem prover adds a new clause to the clause set, this transformation may thus be performed automatically prior to adding the new clause to the clause set. Further, the unsatisfiability test may be established as post-operation callback code 220, to ensure its performance after addition of the new clause. As a result, the transformation and unsatisfiability test need be included in the code only once each. Without the callback system 100, in contrast, the transformation and unsatisfiability test would need to be explicitly called by the user code each time they are needed, which would lead to more complex code as well as larger code.

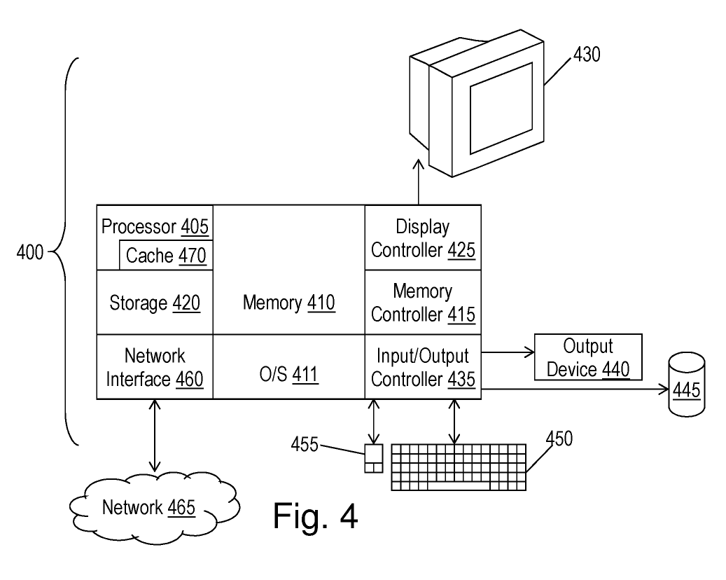

FIG. 4 illustrates a block diagram of a computer system 400 for use in implementing a callback system 100 or method 300 according to some embodiments. The callback systems 100 and methods 300 described herein may be implemented in hardware, software (e.g., firmware), or a combination thereof. In some embodiments, the methods described may be implemented, at least in part, in hardware and may be part of the microprocessor of a special or general-purpose computer system 400, such as a personal computer, workstation, minicomputer, or mainframe computer.

In some embodiments, as shown in FIG. 4, the computer system 400 includes a processor 405, memory 410 coupled to a memory controller 415, and one or more input devices 445 and/or output devices 440, such as peripherals, that are communicatively coupled via a local I/O controller 435. These devices 440 and 445 may include, for example, a printer, a scanner, a microphone, and the like. Input devices such as a conventional keyboard 450 and mouse 455 may be coupled to the I/O controller 435. The I/O controller 435 may be, for example, one or more buses or other wired or wireless connections, as are known in the art. The I/O controller 435 may have additional elements, which are omitted for simplicity, such as controllers, buffers (caches), drivers, repeaters, and receivers, to enable communications.

The I/O devices 440, 445 may further include devices that communicate both inputs and outputs, for instance disk and tape storage, a network interface card (MC) or modulator/demodulator (for accessing other files, devices, systems, or a network), a radio frequency (RF) or other transceiver, a telephonic interface, a bridge, a router, and the like.

The processor 405 is a hardware device for executing hardware instructions or software, particularly those stored in memory 410. The processor 405 may be a custom made or commercially available processor, a central processing unit (CPU), an auxiliary processor among several processors associated with the computer system 400, a semiconductor based microprocessor (in the form of a microchip or chip set), a macroprocessor, or other device for executing instructions. The processor 405 includes a cache 470, which may include, but is not limited to, an instruction cache to speed up executable instruction fetch, a data cache to speed up data fetch and store, and a translation lookaside buffer (TLB) used to speed up virtual-to-physical address translation for both executable instructions and data. The cache 470 may be organized as a hierarchy of more cache levels (L1, L2, etc.).

The memory 410 may include one or combinations of volatile memory elements (e.g., random access memory, RAM, such as DRAM, SRAM, SDRAM, etc.) and nonvolatile memory elements (e.g., ROM, erasable programmable read only memory (EPROM), electronically erasable programmable read only memory (EEPROM), programmable read only memory (PROM), tape, compact disc read only memory (CD-ROM), disk, diskette, cartridge, cassette or the like, etc.). Moreover, the memory 410 may incorporate electronic, magnetic, optical, or other types of storage media. Note that the memory 410 may have a distributed architecture, where various components are situated remote from one another but may be accessed by the processor 405.

The instructions in memory 410 may include one or more separate programs, each of which comprises an ordered listing of executable instructions for implementing logical functions. In the example of FIG. 4, the instructions in the memory 410 include a suitable operating system (OS) 411. The operating system 411 essentially may control the execution of other computer programs and provides scheduling, input-output control, file and data management, memory management, and communication control and related services.

Additional data, including, for example, instructions for the processor 405 or other retrievable information, may be stored in storage 420, which may be a storage device such as a hard disk drive or solid state drive. The stored instructions in memory 410 or in storage 420 may include those enabling the processor to execute one or more aspects of the callback systems 100 and methods 300 of this disclosure.

The computer system 400 may further include a display controller 425 coupled to a display 430. In some embodiments, the computer system 400 may further include a network interface 460 for coupling to a network 465. The network 465 may be an IP-based network for communication between the computer system 400 and an external server, client and the like via a broadband connection. The network 465 transmits and receives data between the computer system 400 and external systems. In some embodiments, the network 465 may be a managed IP network administered by a service provider. The network 465 may be implemented in a wireless fashion, e.g., using wireless protocols and technologies, such as WiFi, WiMax, etc. The network 465 may also be a packet-switched network such as a local area network, wide area network, metropolitan area network, the Internet, or other similar type of network environment. The network 465 may be a fixed wireless network, a wireless local area network (LAN), a wireless wide area network (WAN) a personal area network (PAN), a virtual private network (VPN), intranet or other suitable network system and may include equipment for receiving and transmitting signals.

Callback systems 100 and methods 300 according to this disclosure may be embodied, in whole or in part, in computer program products or in computer systems 400, such as that illustrated in FIG. 4.

Technical effects and benefits of some embodiments include enabling a container class 120 to support automated callback functionality upon initiation of a container action. As a result, coding that utilizes the container class 120 may be smaller and more easily maintained, as well as potentially less complex.

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof.

The corresponding structures, materials, acts, and equivalents of all means or step plus function elements in the claims below are intended to include any structure, material, or act for performing the function in combination with other claimed elements as specifically claimed. The description of the present invention has been presented for purposes of illustration and description, but is not intended to be exhaustive or limited to the invention in the form disclosed. Many modifications and variations will be apparent to those of ordinary skill in the art without departing from the scope and spirit of the invention. The embodiments were chosen and described in order to best explain the principles of the invention and the practical application, and to enable others of ordinary skill in the art to understand the invention for various embodiments with various modifications as are suited to the particular use contemplated.

The present invention may be a system, a method, and/or a computer program product. The computer program product may include a computer readable storage medium (or media) having computer readable program instructions thereon for causing a processor to carry out aspects of the present invention.

The computer readable storage medium can be a tangible device that can retain and store instructions for use by an instruction execution device. The computer readable storage medium may be, for example, but is not limited to, an electronic storage device, a magnetic storage device, an optical storage device, an electromagnetic storage device, a semiconductor storage device, or any suitable combination of the foregoing. A non-exhaustive list of more specific examples of the computer readable storage medium includes the following: a portable computer diskette, a hard disk, a random access memory (RAM), a read-only memory (ROM), an erasable programmable read-only memory (EPROM or Flash memory), a static random access memory (SRAM), a portable compact disc read-only memory (CD-ROM), a digital versatile disk (DVD), a memory stick, a floppy disk, a mechanically encoded device such as punch-cards or raised structures in a groove having instructions recorded thereon, and any suitable combination of the foregoing. A computer readable storage medium, as used herein, is not to be construed as being transitory signals per se, such as radio waves or other freely propagating electromagnetic waves, electromagnetic waves propagating through a waveguide or other transmission media (e.g., light pulses passing through a fiber-optic cable), or electrical signals transmitted through a wire.

Computer readable program instructions described herein can be downloaded to respective computing/processing devices from a computer readable storage medium or to an external computer or external storage device via a network, for example, the Internet, a local area network, a wide area network and/or a wireless network. The network may comprise copper transmission cables, optical transmission fibers, wireless transmission, routers, firewalls, switches, gateway computers and/or edge servers. A network adapter card or network interface in each computing/processing device receives computer readable program instructions from the network and forwards the computer readable program instructions for storage in a computer readable storage medium within the respective computing/processing device.

Computer readable program instructions for carrying out operations of the present invention may be assembler instructions, instruction-set-architecture (ISA) instructions, machine instructions, machine dependent instructions, microcode, firmware instructions, state-setting data, or either source code or object code written in any combination of one or more programming languages, including an object oriented programming language such as Java, Smalltalk, C++ or the like, and conventional procedural programming languages, such as the “C” programming language or similar programming languages. The computer readable program instructions may execute entirely on the user's computer, partly on the user's computer, as a stand-alone software package, partly on the user's computer and partly on a remote computer or entirely on the remote computer or server. In the latter scenario, the remote computer may be connected to the user's computer through any type of network, including a local area network (LAN) or a wide area network (WAN), or the connection may be made to an external computer (for example, through the Internet using an Internet Service Provider). In some embodiments, electronic circuitry including, for example, programmable logic circuitry, field-programmable gate arrays (FPGA), or programmable logic arrays (PLA) may execute the computer readable program instructions by utilizing state information of the computer readable program instructions to personalize the electronic circuitry, in order to perform aspects of the present invention.

Aspects of the present invention are described herein with reference to flowchart illustrations and/or block diagrams of methods, apparatus (systems), and computer program products according to embodiments of the invention. It will be understood that each block of the flowchart illustrations and/or block diagrams, and combinations of blocks in the flowchart illustrations and/or block diagrams, can be implemented by computer readable program instructions.

These computer readable program instructions may be provided to a processor of a general purpose computer, special purpose computer, or other programmable data processing apparatus to produce a machine, such that the instructions, which execute via the processor of the computer or other programmable data processing apparatus, create means for implementing the functions/acts specified in the flowchart and/or block diagram block or blocks. These computer readable program instructions may also be stored in a computer readable storage medium that can direct a computer, a programmable data processing apparatus, and/or other devices to function in a particular manner, such that the computer readable storage medium having instructions stored therein comprises an article of manufacture including instructions which implement aspects of the function/act specified in the flowchart and/or block diagram block or blocks.

The computer readable program instructions may also be loaded onto a computer, other programmable data processing apparatus, or other device to cause a series of operational steps to be performed on the computer, other programmable apparatus or other device to produce a computer implemented process, such that the instructions which execute on the computer, other programmable apparatus, or other device implement the functions/acts specified in the flowchart and/or block diagram block or blocks.

The flowchart and block diagrams in the Figures illustrate the architecture, functionality, and operation of possible implementations of systems, methods, and computer program products according to various embodiments of the present invention. In this regard, each block in the flowchart or block diagrams may represent a module, segment, or portion of instructions, which comprises one or more executable instructions for implementing the specified logical function(s). In some alternative implementations, the functions noted in the block may occur out of the order noted in the figures. For example, two blocks shown in succession may, in fact, be executed substantially concurrently, or the blocks may sometimes be executed in the reverse order, depending upon the functionality involved. It will also be noted that each block of the block diagrams and/or flowchart illustration, and combinations of blocks in the block diagrams and/or flowchart illustration, can be implemented by special purpose hardware-based systems that perform the specified functions or acts or carry out combinations of special purpose hardware and computer instructions.

The descriptions of the various embodiments of the present invention have been presented for purposes of illustration, but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

What is claimed is:

1. A computer-implemented method comprising:
associating callback code with an instance of a container class, wherein the callback code includes a callback operation to be performed automatically responsive to a container action;
detecting from user code an initiation of the container action in the instance of the container class; and
automatically, by a computer processor, executing the callback code, responsive to the initiation of the container action.

2. The computer-implemented method of claim 1, wherein the associating the callback code with the instance of the container class is performed during runtime.

3. The computer-implemented method of claim 1, further comprising:
receiving a type parameter at the callback code;
detecting, based on the type parameter, a type of the container action;
performing a callback operation in the callback code if the type parameter meets performance criteria; and
skipping the callback operation in the callback code if the type parameter fails to meet the performance criteria.

4. The computer-implemented method of claim 1, wherein the automatically executing the callback code comprises executing the callback code before the container action and after the container action.

5. The computer-implemented method of claim 4, further comprising:
receiving a timing parameter at the callback code;
detecting, based on the timing parameter, that the callback code is being executed before the container action; and
deciding whether to perform a callback operation in the callback code based on the callback code being executed before the container action.

6. The computer-implemented method of claim 1, further comprising disassociating the callback code from the instance of the container class.

7. The computer-implemented method of claim 1, further comprising:
associating two or more callback codes with the instance of the container class, wherein each callback code of the two or more callback codes includes a respective callback operation to be performed automatically responsive to a container action;
ordering each callback code of the two or more callback codes in a user order relative to one another and relative to the container action; and
automatically executing the two or more callback codes in the user order, responsive to the initiation of the container action.

8. A system comprising:
a memory having computer readable instructions; and
one or more processors for executing the computer readable instructions, the computer readable instructions comprising:
associating callback code with an instance of a container class, wherein the callback code includes a callback operation to be performed automatically responsive to a container action;
detecting from user code an initiation of the container action in the instance of the container class; and
automatically executing the callback code, responsive to the initiation of the container action.

9. The system of claim 8, wherein the associating the callback code with the instance of the container class is performed during runtime.

10. The system of claim 8, the computer readable instructions further comprising:
receiving a type parameter at the callback code;
detecting, based on the type parameter, a type of the container action;
performing a callback operation in the callback code if the type parameter meets performance criteria; and
skipping the callback operation in the callback code if the type parameter fails to meet the performance criteria.

11. The system of claim 8, wherein the automatically executing the callback code comprises executing the callback code before the container action and after the container action.

12. The system of claim 11, the computer readable instructions further comprising:
receiving a timing parameter at the callback code;
detecting, based on the timing parameter, that the callback code is being executed before the container action; and
deciding whether to perform a callback operation in the callback code based on the callback code being executed before the container action.

13. The system of claim 8, the computer readable instructions further comprising disassociating the callback code from the instance of the container class.

14. The system of claim 8, the computer readable instructions further comprising:
associating two or more callback codes with the instance of the container class, wherein each callback code of the two or more callback codes includes a respective callback operation to be performed automatically responsive to a container action;
ordering each callback code of the two or more callback codes in a user order relative to one another and relative to the container action; and
automatically executing the two or more callback codes in the user order, responsive to the initiation of the container action.

15. A computer program product for container class callback, the computer program product comprising a computer readable storage medium having program instructions embodied therewith, the program instructions executable by a processor to cause the processor to perform a method comprising:
associating callback code with an instance of a container class, wherein the callback code includes a callback operation to be performed automatically responsive to a container action;
detecting from user code an initiation of the container action in the instance of the container class; and
automatically executing the callback code, responsive to the initiation of the container action.

16. The computer program product of claim 15, wherein the associating the callback code with the instance of the container class is performed during runtime.

17. The computer program product of claim 15, the method further comprising:
receiving a type parameter at the callback code;
detecting, based on the type parameter, a type of the container action;
performing a callback operation in the callback code if the type parameter meets performance criteria; and
skipping the callback operation in the callback code if the type parameter fails to meet the performance criteria.

18. The computer program product of claim 15, wherein the automatically executing the callback code comprises executing the callback code before the container action and after the container action.

19. The computer program product of claim 18, the method further comprising:
receiving a timing parameter at the callback code;
detecting, based on the timing parameter, that the callback code is being executed before the container action; and
deciding whether to perform a callback operation in the callback code based on the callback code being executed before the container action.

20. The computer program product of claim 15, the method further comprising disassociating the callback code from the instance of the container class.
